(19) United States
(12) Patent Application Publication
(10) Pub. No.: US 2013/0088205 A1
(43) Pub. Date: Apr. 11, 2013

(54) VOLTAGE REGULATION SYSTEM AND METHOD

(71) Applicants: Chad Zook, Anderson, IN (US); Robert R. Steele, JR., Lapel, IN (US); Mingshe Zhou, Fishers, IN (US); Tom Merrill, Noblesville, IN (US)

(72) Inventors: Chad Zook, Anderson, IN (US); Robert R. Steele, JR., Lapel, IN (US); Mingshe Zhou, Fishers, IN (US); Tom Merrill, Noblesville, IN (US)

(21) Appl. No.: 13/270,408

(22) Filed: Oct. 11, 2011

(51) Int. Cl. H02P 9/48; H01R 43/00

(52) U.S. Cl. 322/28; 29/825

(57) ABSTRACT

Embodiments of the invention provide an electric machine module including a housing. The module can include an electric machine positioned within the housing. The electric machine can include a field coil and a stator assembly. The module can include a rectifier assembly coupled to the housing and electrically connect to the stator assembly. The rectifier assembly can include at least one output post. A voltage regulator is coupled to the housing and includes at least one field post and a sense post. The voltage regulator is electrically connected to the rectifier assembly. The module can include a remote sense terminal coupled to the housing. A sense switch circuit is electrically coupled to at least the remote sense terminal, the sense post, and the at least one output post.

### BACKGROUND

Some conventional electric machines control electric machine output using voltage regulation. For example, some electric machines include a voltage regulator electrically coupled to an output terminal to measure the voltage of the machine output. Accordingly, the voltage regulator of some electric machines can adjust machine operations so that machine output voltage is substantially similar to a pre-selected voltage necessary for operations of some downstream elements.

### SUMMARY

Some embodiments of the invention provide an electric machine module. In some embodiments, the module can include a housing that can at least partially define a machine cavity. In some embodiments, an electric machine can be at least partially disposed within the machine cavity and at least partially enclosed by the housing. In some embodiments, the electric machine can include a field coil, a rotor assembly, and a stator assembly. In some embodiments, a rectifier assembly can be coupled to the housing and can be electrically connected to the stator assembly. In some embodiments, a voltage regulator can be coupled to the housing and can be electrically connected to the rectifier assembly. In some embodiments, the voltage regulator can include a sense post and at least one field post that can be electrically connected to the field coil. In some embodiments, at least one output post can be coupled to the rectifier assembly and at least one remote sense terminal can be coupled to a portion of the housing. In some embodiments, a sense switch circuit can be electrically connected to at least the remote sense terminal, at least one output post, and the sense post.

Some embodiments of the invention provide an electric machine module. In some embodiments, the module can include a housing that can at least partially define a machine cavity. In some embodiments, an electric machine can be at least partially disposed within the machine cavity and at least partially enclosed by the housing. In some embodiments, the electric machine can include a field coil, a rotor assembly, and a stator assembly. In some embodiments, a rectifier assembly can be coupled to the housing and can be electrically connected to the stator assembly. In some embodiments, the rectifier assembly can include a first output post and a second output post. In some embodiments, a voltage regulator can be coupled to the housing and can be electrically connected to the rectifier assembly. In some embodiments, the voltage regulator can include a sense post and at least one field post that can be electrically connected to the field coil. In some embodiments, a remote sense terminal can be coupled to a portion of the housing. In some embodiments, a sense switch circuit can comprise at least three connection locations. In some embodiments, the sense switch circuit can be electrically connected to at least the remote sense terminal at a first connection location, the first output post at a second connection location, and the sense post at a third connection location. In some embodiments, the sense switch circuit can comprise at least one diode disposed between the first connection location and the third connection location and at least one transistor disposed between the second connection location and the third connection location.

DESCRIPTION OF THE DRAWINGS

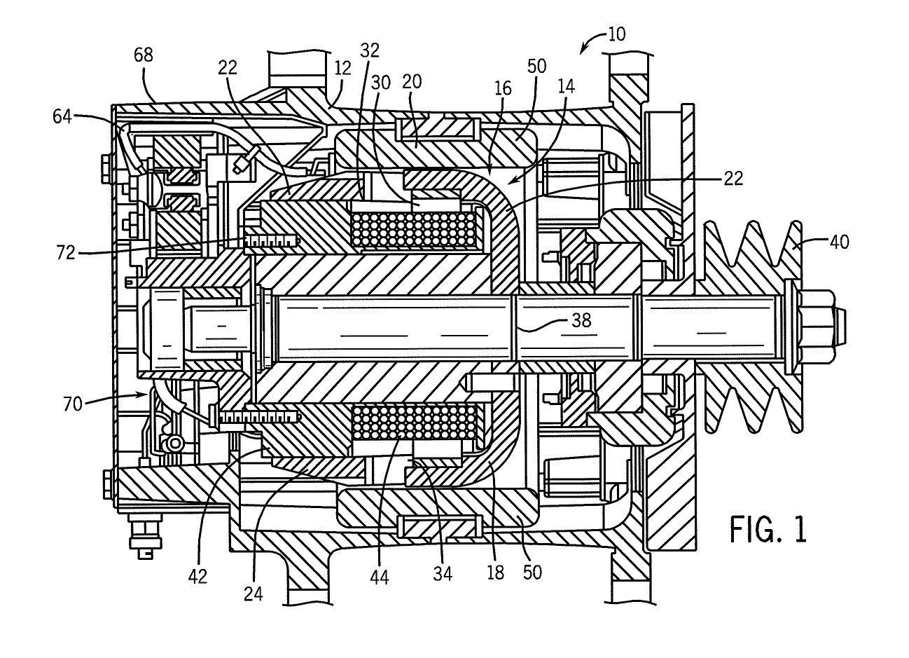

FIG. 1 is a cross-sectional view of an electric machine module according to one embodiment of the invention.

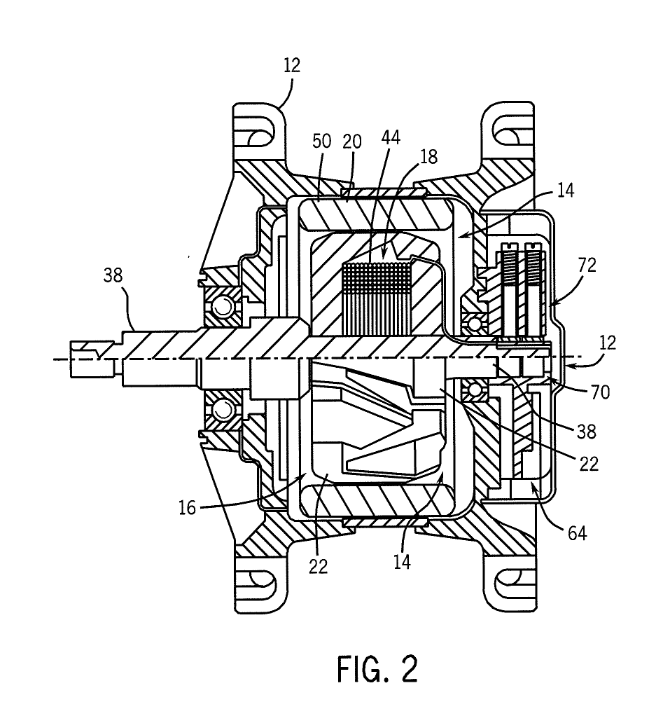

FIG. 2 is a cross-sectional view of an electric machine module according to one embodiment of the invention.

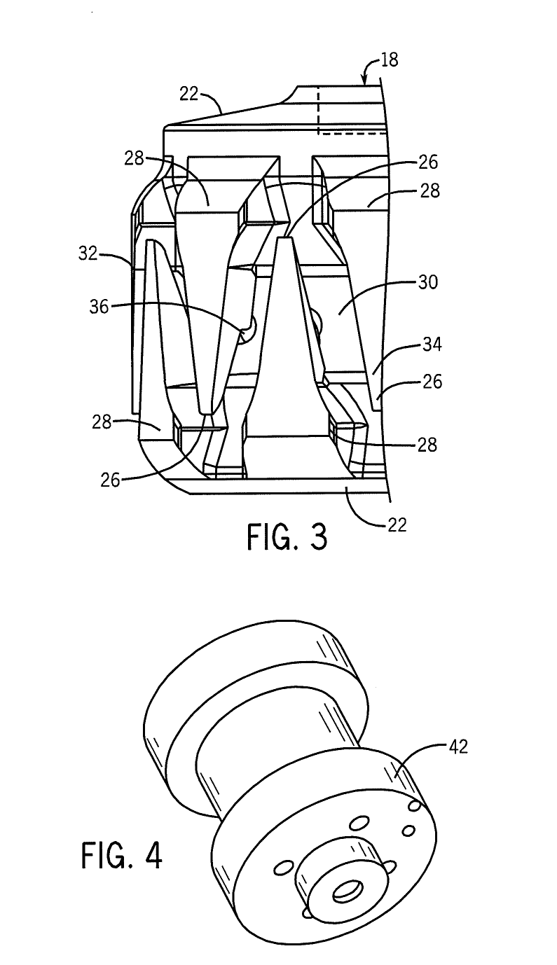

FIG. 3 is a partial view of a portion of a rotor assembly according to one embodiment of the invention.

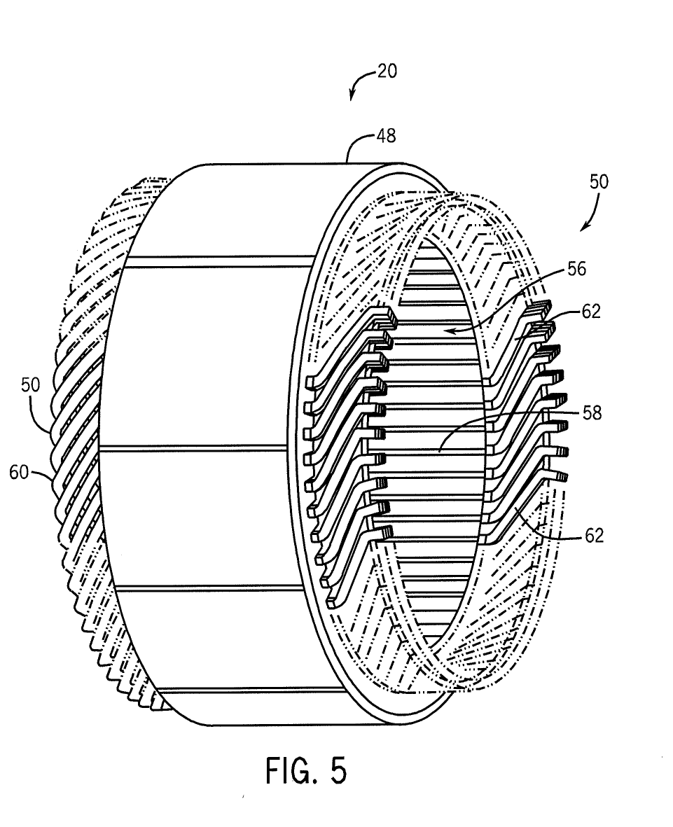

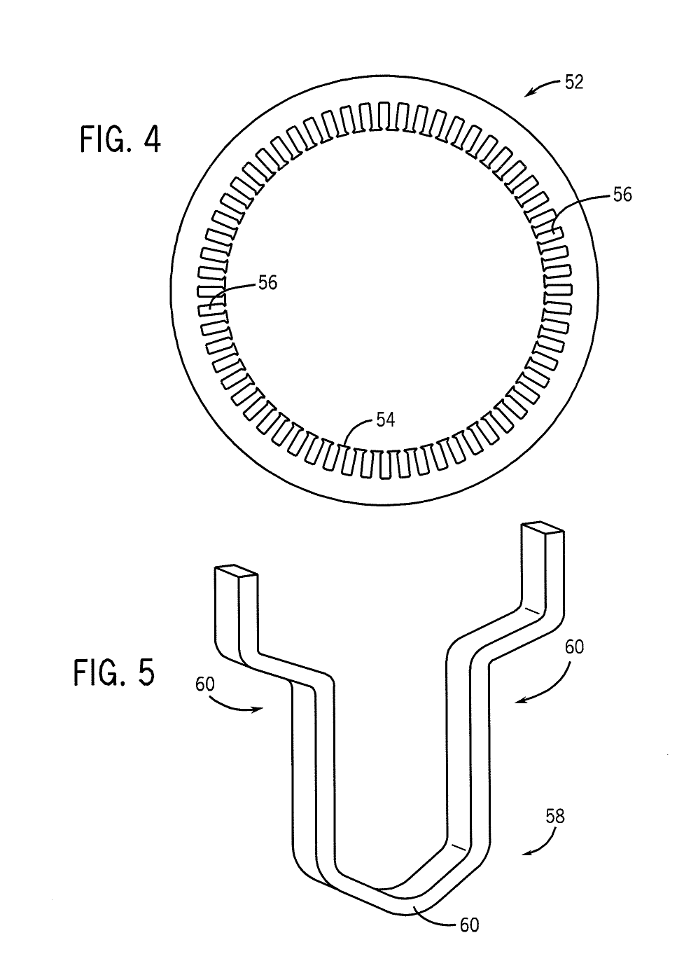

FIG. 4 is a perspective view of a support member according to one embodiment of the invention.

FIG. 5 is a perspective view of a stator assembly according to one embodiment of the invention.

FIG. 6 is a partial view of a stator lamination according to one embodiment of the invention.

FIG. 7 is a perspective view of a conductor according to one embodiment of the invention.

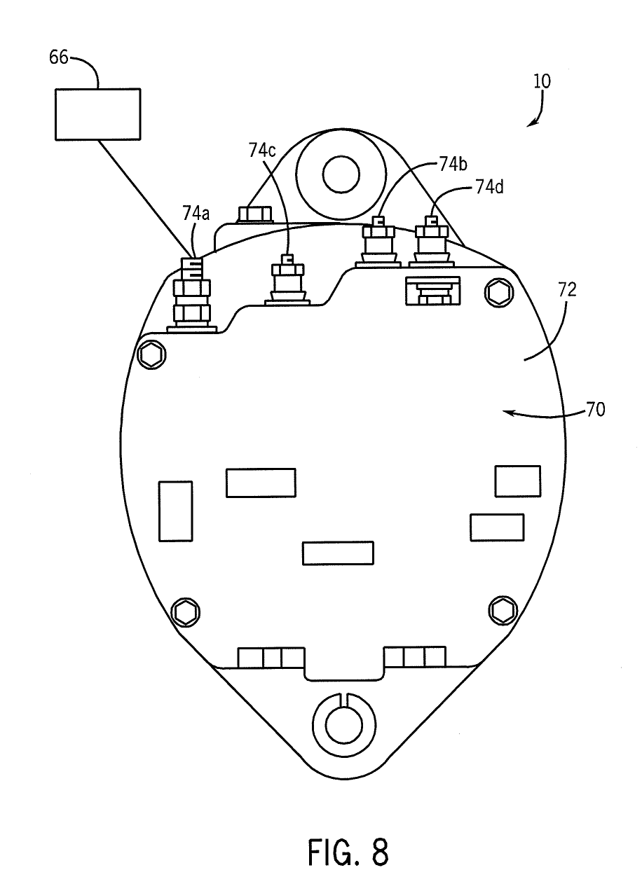

FIG. 8 is a front view of a portion of an electric machine module according to one embodiment of the invention.

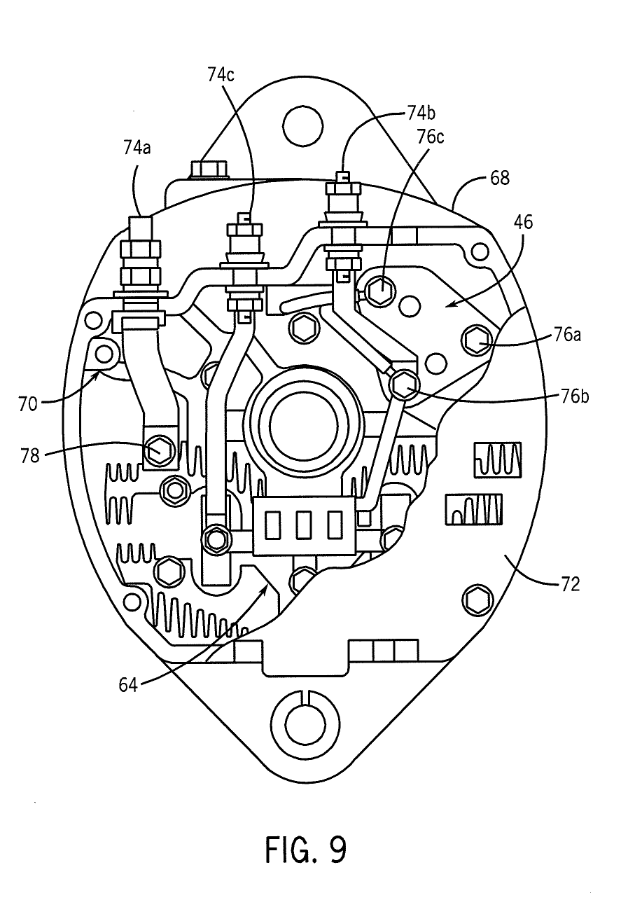

FIG. 9 is a front view of a portion of an electric machine module according to one embodiment of the invention.

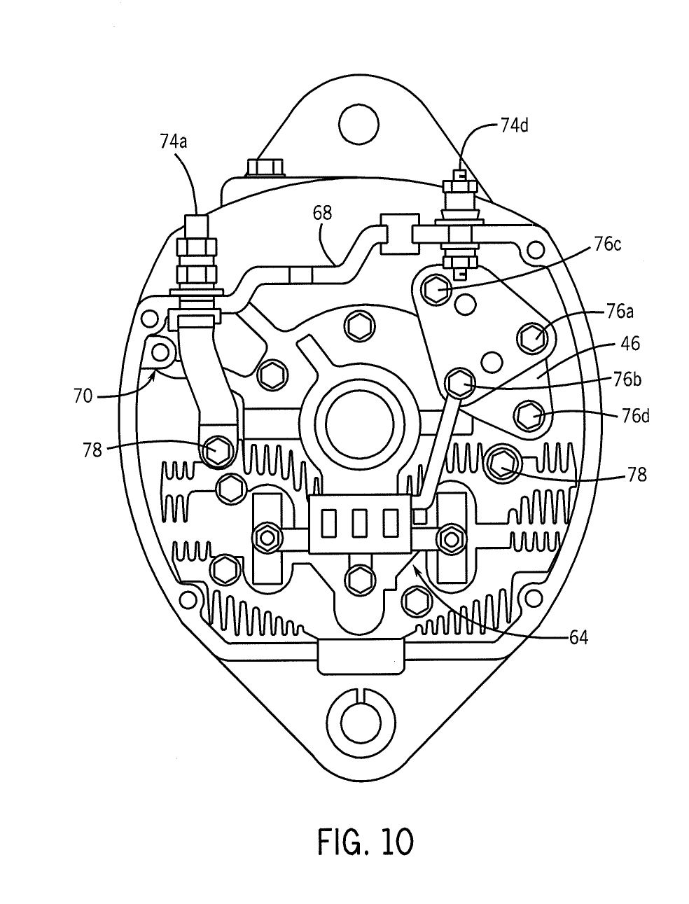

FIG. 10 is a front a portion of an electric machine module according to one embodiment of the invention.

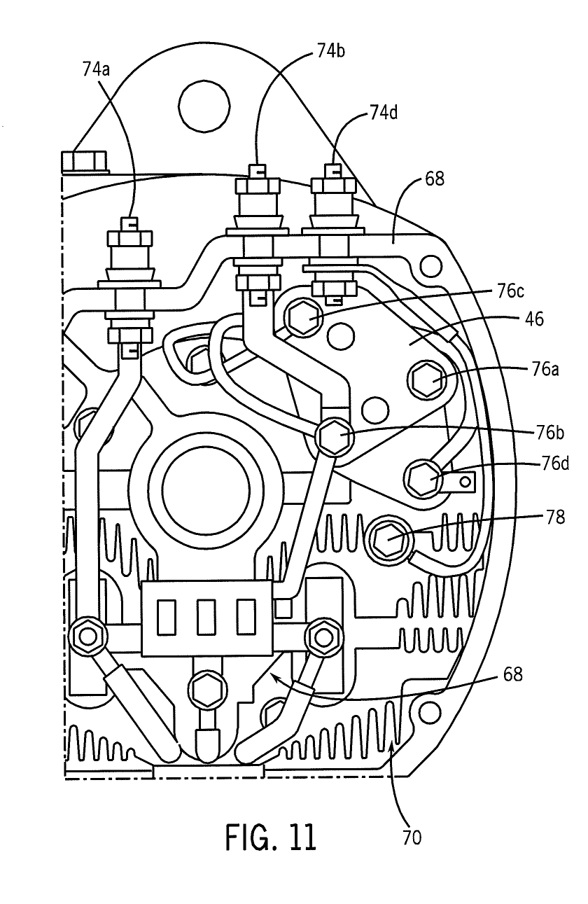

FIG. 11 is a front view a portion of an electric machine module according to one embodiment of the invention.

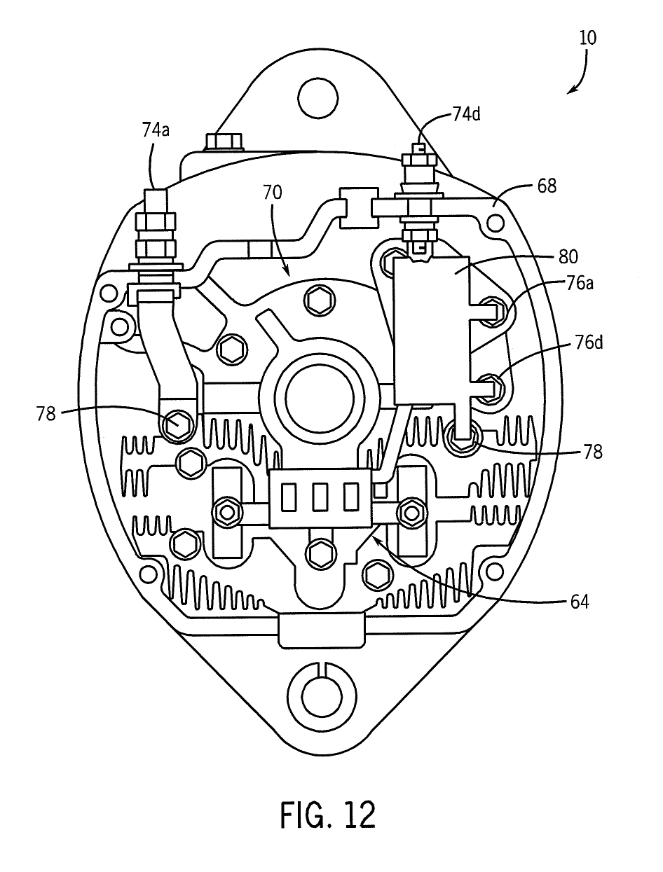

FIG. 12 is a front view a portion of an electric machine module according to one embodiment of the invention.

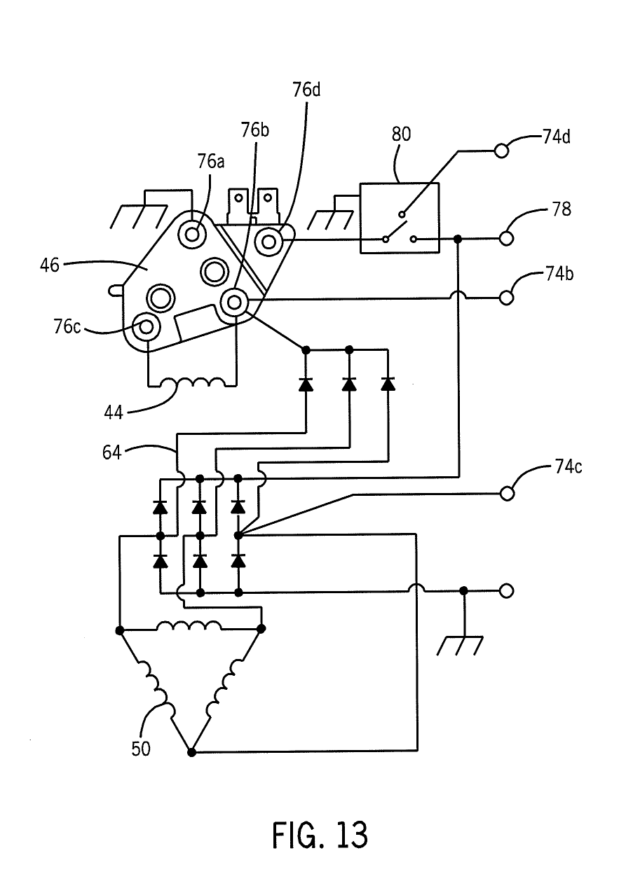

FIG. 13 an electrical wiring diagram of an electric machine module according to one embodiments of the invention.

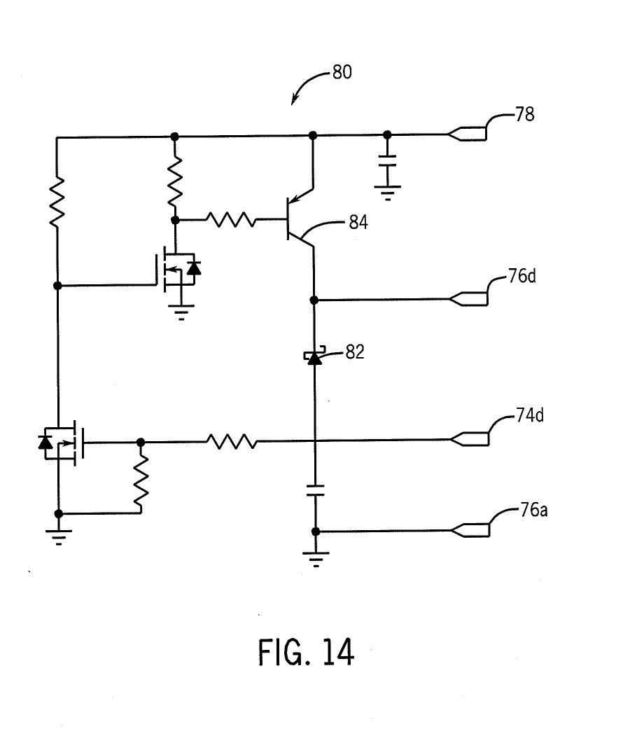

FIG. 14 is an electrical wiring diagram of a sense switch circuit according to one embodiment of the invention.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

The following discussion is presented to enable a person skilled in the art to make and use embodiments of the invention. Various modifications to the illustrated embodiments will be readily apparent to those skilled in the art, and the generic principles herein can be applied to other embodiments and applications without departing from embodiments of the invention. Thus, embodiments of the invention are not intended to be limited to embodiments shown, but are to be accorded the widest scope consistent with the principles and features disclosed herein. The following detailed description is to be read with reference to the figures, in which like elements in different figures have like reference numerals. The figures, which are not necessarily to scale, depict selected embodiments and are not intended to limit the scope of embodiments of the invention. Skilled artisans will recognize the examples provided herein have many useful alternatives and fall within the scope of embodiments of the invention.

FIG. 1 illustrates an electric machine module 10 according to one embodiment of the invention. The module 10 can include a housing 12, which can define at least a portion of a machine cavity 14. In some embodiments, an electric machine 16 can be housed within the machine cavity 14 and at least partially enclosed by the housing 12. In some embodiments, the housing 12 can comprise materials that can generally include thermally conductive properties, such as, but not limited to aluminum or other metals and materials capable of generally withstanding operating temperatures of the electric machine 16. In some embodiments, the housing 12 can be fabricated using different methods including casting, molding, extruding, and other similar manufacturing methods. In some embodiments, the electric machine 16 can be, without limitation, an electric motor, such as a hybrid electric motor, an electric generator, a vehicle alternator, and/or an induction belt-driven alternator-starter (BAS).

In some embodiments, the electric machine 16 can include a rotor assembly 18 and a stator assembly 20. In some embodiments, the stator assembly 20 can circumscribe at least a portion of the rotor assembly 18. In some embodiments, the rotor assembly 18 can include at least two matingly-configured segments 22 coupled together. In some embodiments, the segments 22 can comprise a Lundell-type configuration. In some embodiments, the segments 22 can each include a plurality of claw poles 24 that are configured and arranged to matingly engage each other. For example, in some embodiments, at least a portion of the claw poles 24 can be configured and arranged so that during assembly, some of the claw poles 24 can axially integrate (e.g., matingly engage and/or interdigitate) so that a tip 26 of a claw pole 24 on one segment 22 is substantially adjacent to a base 28 of a claw pole 24 on the other segment 22, as shown in FIG. 3.

In some embodiments, during assembly of the module 10, the two segments 22 can be coupled together. In some embodiments, the segments 22 can be at least partially coupled by a ring member 30. In some embodiments, the segments 22 can be coupled to at least a portion of the ring member 30. For example, in some embodiments, the ring member 30 can comprise a first axial edge 32 and a second axial edge 34 and one of the segments 22 can be coupled to the ring member 30 substantially adjacent to the first axial edge 32 and the other segment 22 can be coupled to the ring member 30 substantially adjacent to the second axial edge 34. For example, in some embodiments, at least one of the segments 22 can be coupled to the ring member 30 using welding, brazing, adhesives, conventional fasteners, etc. As a result, in some embodiments, the segments 22 can be axially positioned with respect to the ring member 30 (i.e., the ring member 30 can be substantially centrally positioned with respect to the segments 22). In some embodiments, the ring member 30 can comprise a substantially magnetically inert material, such as stainless steel. Additionally, in some embodiments, the ring member 30 can comprise a plurality of apertures 36 positioned through portions of the ring member 30 in a substantially circumferential orientation.

In some embodiments, the electric machine 16 can comprise a shaft 38. In some embodiments, at least one of the segments 22 can be operatively coupled to the shaft 38. For example, in some embodiments, at least one of the segments 22 can be rotatably coupled to the shaft 38 so that rotation of the shaft 38 can be directly translated to the rotor assembly 18 (e.g., the rotor assembly 18 and the shaft 38 can substantially synchronously rotate). Additionally, in some embodiments, the shaft 38 can be coupled to a pulley 40. In some embodiments, the pulley 40 can be coupled to a conventional energy generation apparatus (not shown) to provide a force to rotate the pulley 40, which can be translated to rotation of the shaft 38 and the rotor assembly 18. By way of example only, in some embodiments, the pulley 40 can be coupled to an engine via a belt (not shown) so that rotation of the belt can rotate the pulley 40.

In some embodiments, the rotor assembly 18 can substantially circumscribe at least a portion of a support member 42 that can include a field coil 44. In some embodiments, the support member 42 can be coupled to a portion of the housing 12 so that during operation of the module 10, the support member 42 can remain substantially stationary. Moreover, in some embodiments, the support member 42 can be coupled to the housing 12 so that it axially extends into the machine cavity 14 and can be received by at least a portion of the rotor assembly 18. In some embodiments, the support member 42 can be coupled to the housing 12 using conventional fasteners, and in other embodiments, the support member 42 can be coupled to the housing 12 in other manners or the support member 42 can be substantially integral with the housing 12. Additionally, in some embodiments, the support member 42 can comprise a generally annular configuration, as shown in FIG. 4. In other embodiments, the support member 42 can comprise other configurations (e.g., square, rectangular, regular or irregular polygonal, etc.) that can be received within at least a portion of the rotor assembly 18.

In some embodiments, the field coil 44 can circumscribe at least a portion of the support member 42. In some embodiments, the field coil 44 can comprise at least one wire wound around at least a portion of an outer diameter of the support member 42. For example, in some embodiments, the field coil 44 can be wound around the support member 42 multiple times so that the field coil 44 comprises multiple layers in a generally radial orientation. In some embodiments, the field coil 44 can comprise a copper-containing material.

In some embodiments, the module 10 can comprise a brushless configuration. In some embodiments, the field coil 44 can be electrically connected to a voltage regulator 46 and a current source, such as a rectifier assembly, as described below. As a result, in some embodiments, a current can circulate from the current source via the voltage regulator 46 to the field coil 44 for use in operations of the electric machine 20, as described in further detail below. In some embodiments, as result of the substantially stationary support member 42 and field coil 44, the module 10 can be brushless (e.g., no brushes and/or slip rings are necessary for circulating current through the field coil 44).

In some embodiments, the rotor assembly 18 can comprise other configurations. In some embodiments, the rotor assembly 18 can comprise a brushed configuration. In some embodiments, the segments 22 can be assembled in a different manner. For example, in some embodiments, one of the segments 22 can be coupled to the shaft 38 via any conventional coupling process (e.g., staking, interference fitting, welding, brazing, soldering, etc.) and the field coil 44 can be disposed radially inward from the claw poles 28 of the segment 22 coupled to the shaft 38. In some embodiments, another segment 22 can be disposed axially adjacent to the segment 22 coupled to the shaft 38 so that the claw poles 28 matingly engage and the field coil 44 is disposed between the segments 22. Furthermore, in some embodiments, the second segment 22 can be coupled to the shaft 38 so the segments 22 and the field coil 44 are secured to the shaft 38 and can substantially synchronously rotate with the shaft 38. Moreover, in some embodiments, because the field coil 44 at least partially synchronously rotates with the rotor assembly 18, the module 10 can comprise a brushed configuration. Accordingly, in some embodiments, the voltage regulator 46 can be electrically coupled to at least one brush (not shown) and at least one slip ring (not shown) that can be configured and arranged to engage each other to enable current to flow through the field coil 44 during operation of the module 10.

As shown in FIG. 5, in some embodiments, the stator assembly 20 can comprise a stator core 48 and a stator winding 50 at least partially disposed within a portion of the stator core 48. For example, in some embodiments, the stator core 48 can comprise a plurality of laminations 52. Referring to FIG. 6, in some embodiments, the laminations 52 can comprise a plurality of substantially radially-oriented teeth 54. In some embodiments, as shown in FIGS. 5 and 6, when at least a portion of the plurality of laminations 52 are substantially assembled, the teeth 54 can substantially align to define a plurality of slots 56 that are configured and arranged to support at least a portion of the stator winding 50. As shown in FIGS. 5 and 6, in some embodiments, the laminations 52 can include multiple teeth 54, and, as a result, the stator core 48 can include multiple slots 56.

In some embodiments, the stator winding 50 can comprise a plurality of conductors 58. In some embodiments, the conductors 58 can comprise a substantially segmented configuration (e.g., a hairpin configuration), as shown in FIG. 7. For example, in some embodiments, at least a portion of the conductors 58 can include a turn portion 60 and at least two leg portions 62. In some embodiments, the turn portion 60 can be disposed between the two leg portions 62 to substantially connect the two leg portions 62. In some embodiments, the leg portions 62 can be substantially parallel. Moreover, in some embodiments, the turn portion 60 can comprise a substantially “u-shaped” configuration, although, in some embodiments, the turn portion 60 can comprise a v-shape, a wave shape, a curved shape, and other shapes. Additionally, in some embodiments, as shown in FIG. 7, at least a portion of the conductors 58 can comprise a substantially rectangular cross section. In some embodiments, at least a portion of the conductors 58 can comprise other cross-sectional shapes, such as substantially circular, square, hemispherical, regular or irregular polygonal, etc. In some embodiments, the stator winding 50 can comprise other configurations. In some embodiments, the stator winding 50 can comprise at least one wire disposed in at least a portion of the slots 56. For example, in some embodiments, multiple wires (e.g. three, six, nine, etc.) can be disposed in at least a portion of the slots 56 to form a multi-phase stator winding 50.

For example, in some embodiments, the stator winding 50 can comprise a three-phase stator winding 50 and each phase can be electrically coupled to a rectifier assembly 64 via conventional terminals and leads (not shown). In some embodiments, each phase of the stator winding 50 can be electrically coupled to a terminal. For example, as a result, during electric machine operations, when current flows through the field coil 44 and the rotor assembly 18 is rotating, a voltage can be generated in each of the phases of the stator winding 50 due to the magnetic field produced by the rotor assembly 18 and field coil 44. The voltage generated in each of the phases can create an alternating current that circulates through the conductors 58 and to the rectifier assembly 64 via the terminals and leads. In some embodiments, the rectifier assembly 64 can convert the alternating current produced to direct current for recharging any batteries 66 or other loads electrically connected to the module 10.

In some embodiments, the rectifier assembly 64 and some of the other electrical elements of the module 10 can be coupled to a portion of the housing 12. For example, as shown in FIG. 8, in some embodiments, the housing 12 can comprise an outer wall 68 and the rectifier assembly 64 and the voltage regulator 46 can be coupled to a portion of the outer wall 68. Moreover, in some embodiments, the outer wall 68 can comprise a recess 70 into which the rectifier assembly 64 and at least a portion of the other electrical elements of the module 10 can be disposed, as shown in FIG. 2. In some embodiments, an end cap 72 can be coupled to at least a portion of the outer wall 68 to at least partially protect any components coupled to the outer wall 68 and/or disposed within the recess 70.

In some embodiments, the module 10 can comprise a plurality of terminals 74. For example, as shown in FIG. 8, in some embodiments, the module 10 can comprise one or more terminals 74 disposed through a portion of the housing 12. In some embodiments, the terminals 74 can be disposed through portions of the housing 12 so that they are in electrical communication with the rectifier assembly 64 or at least a portion of the of the other electrical elements of the module 10 (e.g., the voltage regulator 46).

In some embodiments, at least a portion of the terminals 74 can be configured and arranged to electrically connected to elements of the structure into which the module 10 is installed. By way of example only, in some embodiments, the terminals 74 can comprise at least an output terminal 74a, an I terminal 74b, an R terminal 74c, and a remote sense terminal 74d, as shown in FIGS. 8 and 9. In some embodiments, at least a portion of the terminals 74 can be electrically coupled to the rectifier assembly 64. For example, in some embodiments, the output terminal 74a can electrically couple the rectifier assembly 64 to the battery 66 and/or other electrical loads. As a result, in some embodiments, at least a portion of the current generated by the module 10 (e.g., direct current after passing through the rectifier assembly 64) can flow through the output terminal 74a to the battery 66 and other loads.

In some embodiments, the I terminal 74b and the R terminal 74c can be electrically coupled to other elements to provide current. For example, in some embodiments, the I terminal 74b can electrically couple the rectifier assembly 64 and an indicator element (e.g., a lamp and/or any other element that can indicate a state of the module 10) so that if the module 10 malfunctions during operation (e.g., insufficient current production), the indicator element can signal the malfunction to a user (e.g., via illumination of the indicator element) so that the module 10 can be repaired. Furthermore, in some embodiments, the R terminal 74c can electrically couple portions of the rectifier assembly 64 to other elements of the structure into which the module 10 is installed. By way of example only, in some embodiments, the module 10 can be installed in a vehicle and the R terminal 74c can electrically couple a portion of the rectifier assembly 64 to elements such as a tachometer, an hour meter, a charge indicator, and/or other device in the vehicle requiring current. Moreover, in some embodiments, the R terminal 74c can provide current at an at least partially reduced voltage. For example, in some embodiments, the R terminal 74c can provide current at a voltage of approximately one-half of the nominal voltage of the module 10 (e.g., 7 volts for a 14 volt module 10). Moreover, in some embodiments, the I terminal 74b can also be coupled to a portion of the vehicle. For example, in some embodiments, the I terminal 74b can be electrically coupled to an ignition switch (not shown) or a starter (not shown) so that the module 10 can receive signals from other elements to activate module 10 operations.

In some embodiments, the remote sense terminal 74d can be configured and arranged to aid the regulator 46 in sensing voltage at remote locations. By way of example only, in some embodiments, the remote sense terminal 74d can be electrically coupled (e.g., via a wire, lead, etc.) to the battery 66 at a point substantially adjacent to where the output terminal 74a is coupled to the battery 66. As a result, in some embodiments, the voltage of the current entering the battery 66 from the module 10 can be at least partially more accurately reflected in the voltage as measured at the remote sense terminal 74a, relative to other voltage measuring techniques, as described in further detail below.

In some embodiments, the voltage regulator 46 can sense voltage to at least partially regulate operations of the module 10. For example, as shown in FIGS. 9 and 10, in some embodiments, the voltage regulator 46 can be coupled to a portion of the outer wall 68 substantially adjacent to the rectifier assembly 64 and electrically coupled to multiple elements of the module 10. In some embodiments, the voltage regulator 46 can comprise a plurality of posts 76 for use in regulating voltage of the module's 10 output. In some embodiments, the voltage regulator 46 can include a ground post 76a, a positive field post 76b, an negative field post 76c, and a sense post 76d. In some embodiments, at least a portion of the posts 76 can be coupled to other elements of the module 10. For example, in some embodiments, the field posts 76b, 76c can be electrically coupled to the field coil 44 so that current flowing through the field coil 44 can be modulated by these posts 76b, 76c and the voltage regulator 46. Moreover, in some embodiments, the positive field post 76b can be electrically coupled to the rectifier assembly 64. As a result, in some embodiments, current from the rectifier assembly 64 (i.e., direct current) can flow through positive field post 76b, the field coil 44, and the negative field post 76c. In some embodiments, the connection between the positive field post 76c and the rectifier assembly 64 can also provide power to the voltage regulator 46. As described in further detail below, the voltage regulator 46 can at least partially regulate the current flowing through the field coil 44 to change module 10 output. Moreover, as shown in FIG. 11, in some embodiments, the positive post 76b can be electrically coupled to the I terminal 74b so that any signals received through the I terminal 74b can be received by the voltage regulator 46.

In some embodiments, the sense post 76d can function as an input for sensing voltage. For example, as shown in FIGS. 10 and 11, in some embodiments, the rectifier assembly 64 can comprise at least two output posts 78. In some embodiments, one of the output posts 78 can be electrically coupled to the output terminal 74a and another output post 78 can be electrically coupled to the sense post 76d (e.g., an “internal sense” configuration). As a result, the sense post 76d can determine the voltage present at the output terminal 74a because it can detect the voltage present at one of the output posts 78. Then, in some embodiments, the voltage regulator 46 can accordingly adjust current through the field coil 44 via the positive and negative field posts 76b, 76c to adjust the voltage at the output terminal 74a.

For example, in some embodiments, the module 10 can comprise a pre-determined voltage rating (e.g., 14 volts). In some embodiments, if the voltage at the output terminal 74a is sensed to be too great (e.g., 14.8 volts), the voltage regulator 46 can reduce current flowing through the field coil 44 to reduce output. Conversely, if the voltage at the output terminal 74a is sensed to be insufficient (12.3 volts), the voltage regulator 46 can increase current flowing through the field coil 44 to increase output.

In some embodiments, the sense post 76d can be electrically coupled to the remote sense terminal 76d (e.g., a “remote sense” configuration). As previously mentioned, in some embodiments, the remote sense terminal 76d can be electrically coupled to another element within the structure into which the module 10 can be installed (e.g., coupled to the battery 66 at or adjacent to where the output terminal 74a couples to the battery 66). As a result, the voltage present at the battery 66 can be reflected by the voltage present at the remote sense terminal 74d. For example, in some embodiments, because the sense post 76d is electrically coupled to the remote sense terminal 74d, the voltage regulator 46 can effectively detect the voltage present at the battery 66. Accordingly, the voltage regulator 46 can regulate output of the module 10 based on the voltage present at the battery 66.

In some embodiments, remote sense regulation can improve efficiency of the module 10. For example, in some embodiments, during current flow from the output terminal 74a to the battery 66 or other elements, a voltage drop (e.g., 0.3 volts) can be created so that the voltage at the output terminal 74a is greater than the voltage at the battery 66. Accordingly, by regulating voltage based on the voltage sensed at the battery 66 via the remote sense terminal 74d, rather than at the output terminal 74a, the voltage reaching elements outside of the module 10 can be more accurately detected by the regulator 46 and the module's 10 output can be adjusted to reach the desired voltage at the battery 66 for more efficient operations.

In some embodiments of the invention, the module 10 can comprise sense switch circuit 80. As shown in FIGS. 12 and 13, in some embodiments, the sense switch circuit 80 can be coupled to at least a portion of the posts 76 (e.g., the sense post 76d) of the voltage regulator 46, the remote sense terminal 74d, and at least one of the output posts 78. Although depicted as a separate element coupled to voltage regulator 46, in some embodiments, the sense switch circuit 80 can be substantially integral with the voltage regulator 46.

In some embodiments, the sense switch circuit 80 can be configured and arranged to automatically switch voltage detection to and/or from the remote sense terminal 74d and the output posts 78. For example, in some embodiments, after coupling the sense switch circuit 80 to the module 10, the circuit 80 can initially determine whether a voltage is present at the remote sense terminal 74d. In some embodiments, if the sense switch circuit 80 detects that the remote sense terminal 74d comprises a voltage greater than a pre-determined threshold (e.g., 9 volts), the circuit 80 can electrically couple the remote sense terminal 74d and the sense post 76d of the voltage regulator 46 to enable remote sense regulation. Conversely, if the sense switch circuit 80 detects that the remote sense terminal 74d comprises a voltage less than the pre-determined threshold, the circuit 80 can electrically couple the sense terminal 76d and at least one of the output posts 78 to enable an internal sense regulation.

Although use of the remote sense terminal 74d can offer benefits, as previously mentioned, the remote sense terminal 74d can also include drawbacks. In some embodiments, because the remote sense terminal 74d can at least partially extend through portions of the module 10 (i.e., can be exposed to an the outer environment), the terminal 74d can be susceptible to galvanic corrosion. For example, when covered in an electrolytic solution (e.g., salt water), the remote sense terminal 74d can corrode and, possibly become so structurally compromised that it becomes disconnected from the module 10. As a result, the voltage regulator 46 coupled to the now-disconnected remote sense terminal 74d would be unable to regulate operations of the module 10 or could potentially increase module 10 output to an extreme level because the regulator 46 does not sense voltage at the terminal 74d.

In some embodiments, the sense switch circuit 80 can disconnect (e.g., electrically uncouple) the sense post 76d and the sensing input that is not being used. For example, in some embodiments, if the sense switch circuit 80 connects the sense post 76d to the output post 78 of the rectifier assembly 64 (e.g., the circuit 80 did not detect a voltage at the remote sense terminal 74d), then the circuit 80 can uncouple the electrical connection between the sense post 76d and the remote sense terminal 74d or vice versa. As a result, in some embodiments, when uncoupled from the voltage regulator 46 by the sense switch circuit 80, the remote sense terminal 74d will exhibit little to no voltage potential because no current can flow from the regulator 46 to the remote sense terminal 74d, which can function to reduce galvanic corrosion when the terminal 74d is not in use.

Moreover, in some embodiments, the sense switch circuit 80 can alternate between the remote sense terminal 74d and the output post 78. In some embodiments, if the circuit 80 determines that the voltage at the remote sense terminal 74d exceeds the threshold and it connects the sense post 76d and the terminal 74d, the circuit 80 can still switch the connection to the output post 78 if the voltage drops below the threshold. For example, if after coupling the remote sense terminal 74d and the sense post 76d (i.e., a remote sense configuration), the sense switch circuit 80 determines that the voltage at the remote sense terminal 74d drops below the pre-determined threshold, the circuit 80 can uncouple the connection between the terminal 74d and the sense post 76d and couple the sense post 76d and the output post 78 (i.e., an internal sense configuration). As a result, the sense switch circuit 80 can enable usage of a remote sense configuration, but can also function to avoid the drawbacks associated with use of the remote sense terminal 74d should any difficulties arise.

For example, in some embodiments, the sense switch circuit 80 can comprise a substantially similar configuration to the circuit displayed in FIG. 14. As previously mentioned, in some embodiments, the circuit 80 can be coupled to the output post 78, the sense post 76d, the remote sense terminal 74d, and ground. In some embodiments, the circuit 80 can comprise at least one diode 82 (e.g., a schottky diode) and at least one transistor 84 (e.g., a PNP transistor), in addition to other circuit elements shown in FIG. 14. As a result, in some embodiments, when the voltage detected at the remote sense terminal 74d exceeds the pre-determined threshold (e.g., 9 volts), current can flow through the diode 82 to the sense post 76d where the voltage can be sensed by the voltage regulator 46 and current to the field coil 44 can be accordingly regulated. Moreover, if the remote sense terminal 74d comprises a sufficient voltage, the transistor 84 can be substantially deactivated so that little to no current can flow beyond the transistor 84. Conversely, in some embodiments, if the voltage at the remote sense terminal 74d is below the pre-determined threshold, the transistor 84 will be activated to connect the output post 78 and the sense post 76d for voltage sensing by the voltage regulator 46. Moreover, if the voltage at the remote sense terminal 74d is below the pre-determined threshold, the diode 82 can function to substantially isolate the remote sense terminal 74d from the remainder of the active circuit 80.

It will be appreciated by those skilled in the art that while the invention has been described above in connection with particular embodiments and examples, the invention is not necessarily so limited, and that numerous other embodiments, examples, uses, modifications and departures from the embodiments, examples and uses are intended to be encompassed by the claims attached hereto. The entire disclosure of each patent and publication cited herein is incorporated by reference, as if each such patent or publication were individually incorporated by reference herein. Various features and advantages of the invention are set forth in the following claims.

1. An electric machine module comprising:
a housing at least partially defining a machine cavity;
an electric machine disposed within the machine cavity and at least partially enclosed by the housing, the electric machine including a field coil, a rotor assembly, and a stator assembly;
a rectifier assembly being coupled to the housing and being electrically connected to the stator assembly;
a voltage regulator being coupled to the housing and being electrically connected to rectifier assembly, the voltage regulator including a sense post and at least one field post electrically connected to the field coil;
at least one output post being coupled to the rectifier assembly and at least one remote sense terminal being coupled to a portion of the housing; and
a sense switch circuit electrically coupled to at least the remote sense terminal, the at least one output post, and the sense post.

2. The electric machine module of claim 1 and further comprising two output posts electrically connected to the rectifier assembly and an output terminal coupled to a portion of the housing.

3. The electric machine module of claim 2, wherein a first of the output posts is electrically connected to the output terminal and a second of the output posts is electrically connected to the sense switch circuit.

4. The electric machine module of claim 1, wherein the sense switch circuit is configured and arranged to electrically connect the sense post and the remote sense terminal when a voltage at the remote sense terminal exceeds a predetermined value.

5. The electric machine module of claim 4, wherein the sense switch circuit is configured and arranged to substantially electrically disconnect the at least one output post and the sense post when the voltage at the remote sense terminal exceeds the predetermined value.

6. The electric machine module of claim 4, wherein the sense switch circuit is configured and arranged to electrically connect the sense post and the at least one output post when the voltage at the remote sense terminal falls below the predetermined value.

7. The electric machine module of claim 6, wherein the sense switch circuit is configured and arranged to substantially electrically disconnect the remote sense terminal and the sense post when the voltage at the remote sense terminal falls below the predetermined value.

8. The electric machine module of claim 4, wherein the predetermined value comprises at least nine volts.

9. The electric machine module of claim 1, wherein the sense switch circuit comprises at least one transistor disposed between locations where the sense switch circuit electrically connects to the at least one output post and the sense post.

10. The electric machine module of claim 9, wherein the sense switch circuit comprises at least one diode disposed between locations where the sense switch circuit electrically connects to the sense post and the remote sense terminal.

11. An electric machine module comprising:
a housing at least partially defining a machine cavity;
an electric machine disposed within the machine cavity and at least partially enclosed by the housing, the electric machine including a field coil and a stator assembly;
a rectifier assembly being coupled to the housing and being electrically connected to the stator assembly, the rectifier assembly including a first output post and a second output post;
a voltage regulator being coupled to the housing and being electrically connected to rectifier assembly, the voltage regulator including a sense post and at least one field post electrically connected to the field coil;
a remote sense terminal being coupled to a portion of the housing; and
a sense switch circuit comprising at least three connection locations, the sense switch circuit being electrically coupled to at least the remote sense terminal at a first connection location, the first output post at a second connection location, and the sense post at a third connection location, and wherein the sense switch circuit comprises at least one diode between the first connection location and the third connection location and at least one transistor between the second connection location and the third connection location.

12. The electric machine module of claim 11, wherein the sense switch circuit is configured and arranged to electrically connect the sense post and the remote sense terminal when a voltage at the remote sense terminal exceeds a predetermined value.

13. The electric machine module of claim 12, wherein the sense switch circuit is configured and arranged to substantially electrically disconnect the first output post and the sense post when the voltage at the remote sense terminal exceeds the predetermined value.

14. The electric machine module of claim 12, wherein the sense switch circuit is configured and arranged to electrically connect the sense post and the first output post when the voltage at the remote sense terminal falls below the predetermined value.

15. The electric machine module of claim 14, wherein the sense switch circuit is configured and arranged to substantially electrically disconnect the remote sense terminal and the sense post when the voltage at the remote sense terminal falls below the predetermined value.

16. The electric machine module of claim 15, wherein the predetermined value comprises at least nine volts.

17. The electric machine module of claim 11 and further comprising at least one output terminal coupled to the housing and electrically connected to the second output post.

18. The electric machine module of claim 11 and further comprising at least one of an I terminal and an R terminal coupled to the housing.

19. A method of assembling an electric machine module, the method comprising:
providing a housing at least partially defining a machine cavity;
providing an electric machine including a field coil and a stator assembly;
positioning the electric machine within the machine cavity;
coupling a rectifier assembly to a portion of the housing, the rectifier assembly including at least one output post;
electrically coupling the rectifier assembly and the stator assembly;
coupling a voltage regulator to the housing so that the voltage regulator is electrically coupled to the rectifier assembly, the voltage regulator comprising a sense post and at least one field post, and wherein the at least one field post is electrically coupled to the field coil;
coupling a remote sense terminal to a portion of the housing; and
electrically coupling a sense switch circuit to the remote sense terminal, the at least one output post, and the sense post.

20. The method of claim 19, wherein the voltage regulator is configured and arranged to regulate a current flowing through the field coil based on a voltage sensed at one of the remote sense terminal and the at least one output post.
